(19) United States
(12) Patent Application Publication
(10) Pub. No.: US 2015/0199090 A1
(43) Pub. Date: Jul. 16, 2015

(54) DISPLAY DEVICE, DISPLAY CONTROL METHOD, AND NON-TRANSITORY RECORDING MEDIUM STORING COMPUTER READABLE PROGRAM

(71) Applicant: KONICA MINOLTA, INC., Chiyoda-ku, Tokyo (JP)

(72) Inventor: Masayuki KAWAMOTO, Amagasaki-shi (JP)

(73) Assignee: KONICA MINOLTA, INC., Chiyoda-ku, Tokyo (JP)

(21) Appl. No.: 14/594,685

(22) Filed: Jan. 12, 2015

(30) Foreign Application Priority Data
Jan. 15, 2014 (JP) 2014-004964

(51) Int. Cl. G06F 3/0483; G06F 3/0484; G06F 17/22

(52) U.S. Cl. CPC G06F 3/0483; G06F 17/2247; G06F 3/0484

(57) ABSTRACT

A display device includes: a display unit that displays various types of images; and a browser that allows display of plural display screens showing WEB content in the display unit, wherein the browser executes processing of managing an execution state of a process corresponding to each of the display screens displayed in the display unit, determining a display screen in a state of processing continuation under management as a continuous display screen, and selecting a display screen not in the state of processing continuation as a cancel target screen in closing at least one of the plural display screens displayed in the display unit, and closing the display screen selected as the cancel target screen.

The entire disclosure of Japanese Patent Application No. 2014-004964 filed on Jan. 15, 2014 including description, claims, drawings, and abstract are incorporated herein by reference in its entirety.

### BACKGROUND OF THE INVENTION

1. Field of the Invention

The present invention relates to a display device, a display control method, and a non-transitory recording medium storing a computer readable program, and particularly to a display control technology for a display screen displayed by a browser.

2. Description of the Related Art

There are two types of browsers for displaying WEB content, a window-type browser and a tab-type browser. The window-type browser is a browser which opens a plurality of windows to display WEB content, and thus is configured to display different WEB content in individual windows. On the other hand, the tab-type browser is a browser which opens a plurality of tab screens within one window to display a plurality of WEB content, and thus is configured to switch WEB content displayed in the forefront screen within the window to different WEB content by switching tabs. These types of browsers are capable of opening new windows and tabs in accordance with operation by a user, and also capable of automatically opening new windows and tabs based on execution of scripts.

In recent years, browsers of the type noted above are incorporated in display devices such as smartphones and tablet-type devices, and displays of image processing apparatuses called MFP (Multi-functional peripherals) and the like to display WEB content. Particularly, when incorporated in an image processing apparatus, this type of browser accesses a WEB server and displays WEB content. Based on the displayed WEB content, files are downloaded from the WEB server for print output, or data read by scanning is uploaded to the WEB server.

According to the foregoing display devices, a limitation may be set to the memory use capacity usable by the browser in advance so as to avoid excessive occupation of the memory resource by the browser. In this case, the number of the display screens of the windows and tabs openable by the browser is limited. Accordingly, when the number of the display screens already displayed reaches the maximum display number, a new display screen desired to be opened by the browser based on execution of a script is not allowed to open. For overcoming this problem, such a technology has been proposed which automatically cancels the oldest window and displays a new window so as to open the new window under the condition where the number of opened windows has reached the maximum display number (for example, see JP 3-245188 A).

According to the foregoing related art, however, a process for uploading or downloading a file in the oldest window is interrupted in the midst of processing when the oldest window is automatically closed under a processing state of the process. This interruption may cause troubles for a user. Particularly, in case of a display device incorporated in an image processing apparatus, a process of the image processing apparatus associated with a screen is interrupted in the midst of processing as a result of automatic closure of the screen when the screen is any one of a screen in the midst of job setting by the user, a screen indicating a state in the midst of manuscript reading, a screen indicating a state in the midst of uploading of read image data, and a screen indicating a state in the midst of downloading of image data as a printing target, for example. In this case, the user is required to perform the interrupted process again from the start. This inconvenience considerably deteriorates the degree of usability.

According to the tab-type browser, a button for closing all the tabs is displayed at a predetermined position within the screen. When the button is operated by the user, the browser closes all the tabs and ends the activation of the tabs. In this case, a process for uploading or downloading a file executed at least in one of the plural tabs is interrupted, for example, similarly to the above situation. Accordingly, the user is required to perform the interrupted process again from the start, wherefore problems similar to those of the above situation may arise.

### SUMMARY OF THE INVENTION

The present invention has been made to solve the aforementioned problems, and an object of the present invention is to provide a display device, a display control method, and a program capable of preventing automatic interruption of a process in the midst of processing as a result of closure of a display screen showing WEB content.

To achieve at least the abovementioned object, according to an aspect, a display device reflecting one aspect of the present invention comprises a display unit that displays various types of images, and a browser that allows display of plural display screens showing WEB content in the display unit, wherein the browser executes processing of: managing an execution state of a process corresponding to each of the display screens displayed in the display unit; determining a display screen in a state of processing continuation under management as a continuous display screen, and selecting a display screen not in the state of processing continuation as a cancel target screen in closing at least one of the plural display screens displayed in the display unit; and closing the display screen selected as the cancel target screen.

To achieve at least the abovementioned object, according to an aspect, a display control method of a browser that allows display of plural display screens showing WEB content in a predetermined display unit reflecting one aspect of the present invention comprises: (a) managing an execution state of a process corresponding to each of the display screens displayed in the display unit; (b) determining a display screen in a state of processing continuation under management in (a) as a continuous display screen, and selecting a display screen not in the state of processing continuation as a cancel target screen in closing at least one of the plural display screens displayed in the display unit; and (c) closing the display screen selected as the cancel target screen in (b).

To achieve at least the abovementioned object, according to an aspect, a non-transitory recording medium storing a computer readable program executed by a computer that comprises a browser capable of displaying plural display screens showing WEB content reflecting one aspect of the present invention allows the computer to execute the processes of: (a) managing an execution state of a process corresponding to each of the display screens displayed by the browser; (b) determining a display screen in a state of processing continuation under management in (a) as a continuous display screen, and selecting a display screen not in the state of processing continuation as a cancel target screen in closing at least one of the plural display screens displayed in the display unit; and (c) closing the display screen selected as the cancel target screen in (b).

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a figure illustrating a concept of a network system including an image processing apparatus and a server device;

FIG. 2 is a block diagram illustrating an example of hardware configuration and functional configuration of the image processing apparatus;

FIG. 3 is a figure illustrating an example of tab management information;

FIGS. 4A and 4B are figures illustrating a display screen example displayed by a browser;

FIGS. 5A and 5B are figures illustrating a display screen example displayed by a browser;

FIG. 6 is a figure illustrating a display screen example displayed by a browser;

FIG. 7 is a flowchart showing an example of procedures of main processes executed by the browser;

FIG. 8 is a flowchart showing an example of detailed procedures of an initial tab display process;

FIG. 9 is a flowchart showing an example of detailed procedures of a new tab display process;

FIG. 10 is a flowchart showing an example of detailed procedures of a tab display update; and

FIG. 11 is a flowchart showing an example of detailed procedures of an all tab cancel process.

### DESCRIPTION OF THE PREFERRED EMBODIMENTS

Hereinafter, a preferred embodiment of the present invention will be described in detail with reference to the drawings. However, the scope of the invention is not limited to the illustrated examples. Similar components in the embodiment described herein are given similar reference numbers, and the same description of these components is not repeatedly made.

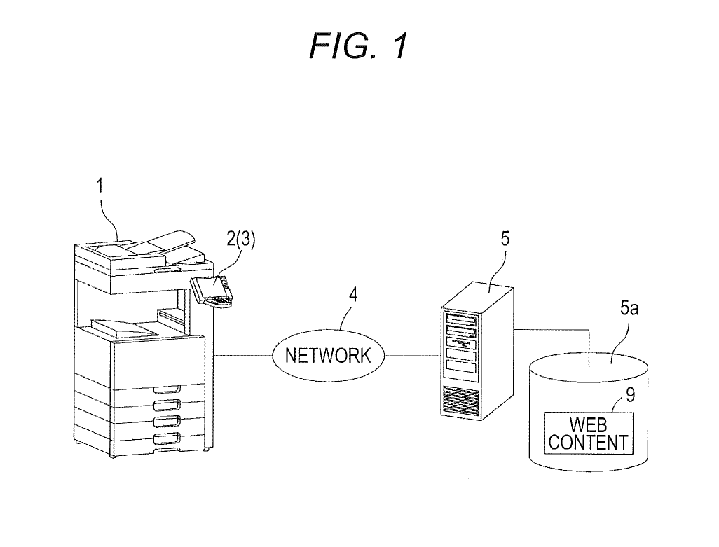

FIG. 1 is a figure illustrating a concept of a network system including an image processing apparatus 1 and a server device 5. The image processing apparatus 1 is constituted by an MFP (Multifunction Peripheral), for example, and performs plural functions such as scan function, print function, copy function, and FAX function. The image processing apparatus 1 is capable of executing jobs designated by a user. The image processing apparatus 1 includes an operation panel 2 disposed on the front side of the device body to receive various types of operations from the user. The operation panel 2 functions as a display device 3 according to the present invention, and shows display screens where various types of information is displayed for the user. The operation panel 2 has a function of displaying WEB content by operation of a browser, and is configured to show a display screen which receives job setting operation from the user, a display screen which receives an instruction for starting job execution, a display screen which indicates a state in the midst of job execution, and other screens by the function of the browser. The image processing apparatus 1 is connected with the server device 5 via a network 4 such as LAN (Local Area Network) and the Internet.

The server device 5 is a device functioning as a WEB server, and includes a storing device 5a storing various types of WEB content 9. The WEB content 9 are display screen information described in HTTP (Hypertext Transfer Protocol), for example, and including scripts (a type of programs) executed by a browser. When receiving a content obtaining request from the browser incorporated in the image processing apparatus 1, the server device 5 reads the WEB content 9 from the storing device 5a, and transmits the WEB content 9 to the image processing apparatus 1 via the network 4. The image processing apparatus 1 receives the WEB content 9 from the server device 5, and displays the WEB content 9 in the operation panel 2. While only the one server device 5 is shown in FIG. 1, the number of the server devices 5 to be connected with the network 4 is not limited to one as in this example. Rather, the multiple server devices 5 are connected in the network environment including the Internet, wherefore the image processing apparatus 1 is configured to access the multiple server devices 5 to obtain the WEB content 9, and display the obtained WEB content 9 in the operation panel 2.

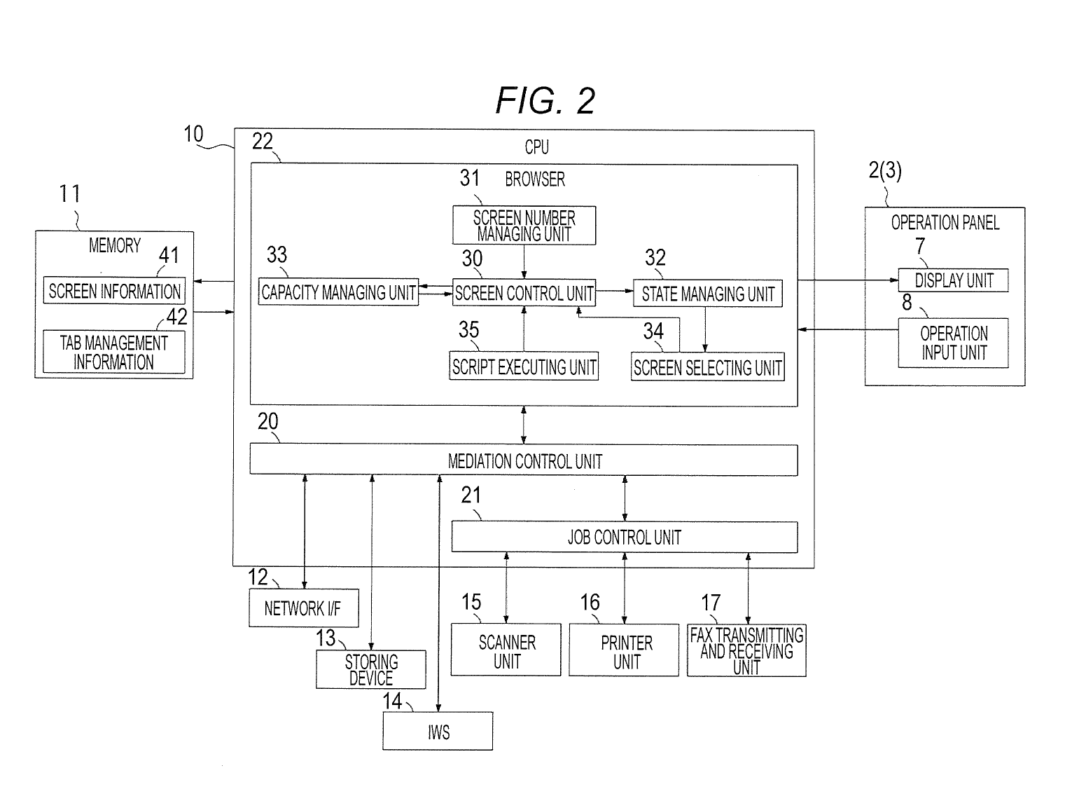

FIG. 2 is a block diagram illustrating an example of hardware configuration and functional configuration of the image processing apparatus 1. The image processing apparatus 1 includes a CPU 10, a memory 11, a network interface 12, a storing device 13, an internal web server (hereinafter abbreviated as “IWS”) 14, a scanner unit 15, a printer unit 16, and a FAX transmitting and receiving unit 17, as well as the operation panel 2 noted above.

As illustrated in FIG. 2, the operation panel 2 includes a display unit 7 and an operation input unit 8. The display unit 7 is constituted by a color liquid crystal display, for example, and is capable of displaying various types of images in a rectangular display area. The operation input unit 8 is constituted by touch panel keys disposed on the front surface of the display area of the display unit 7, and push button keys disposed around the display area of the display unit 7 to receive operation input from the user via the display screen.

The CPU 10 controls operations of the respective units by executing various programs. The memory 11 is a unit for temporarily storing data necessary for the CPU 10 to execute the programs. The network interface 12 is a unit for connecting the image processing apparatus 1 to the network 4. The storing device 13 is a nonvolatile storing device constituted by a hard disk drive (HDD), for example, where various types of programs, data and the like executed by the CPU 10 are stored beforehand, for example. The programs stored in the storing device 13 beforehand include an operating system and a browser program. The CPU 10 executes these programs to function as a mediation control unit 20, a job control unit 21, and a browser 22. The mediation control unit 20 and the job control unit 21 are units which start operation in accordance with activation of the operating system, and are resident in the CPU 10 during power supply to the image processing apparatus 1. The browser 22 is a unit which starts operation in accordance with activation of the browser program under the CPU 10, and displays obtained WEB content in the display unit 7 of the operation panel 2.

The mediation control unit 20 has a function of API (Application Programming Interface), for example, to mediate mutual exchanges of data and commands between the browser 22 and the job control unit 21. Moreover, the mediation control unit 20 mediates communication with the network interface 12, the storing device 13, and the IWS 14 in response to requests from the browser 22 and the job control unit 21.

The job control unit 21 is a unit for controlling execution of jobs in the image processing apparatus 1. The job control unit 21 is configured to perform integrated control over respective operations of the scanner unit 15, the printer unit 16, and the FAX transmitting and receiving unit 17. The job control unit 21 starts job execution which reflects job settings in cooperation with the browser 22.

The IWS 14 has a function of supplying various types of WEB content to the browser 22 during operation of the browser 22 in the CPU 10. Accordingly, the browser 22 may obtain WEB content from the IWS 14 and display the obtained WEB content in the display unit 7. For example, the IWS 14 manages a display screen which receives job setting operation, a display screen which receives an instruction for starting job execution, a display screen which indicates a state in the midst of job execution, and other screens as WEB content, and outputs the WEB content to the browser 22 in response to content obtaining requests from the browser 22. The WEB content managed by the IWS 14 is stored in the storing device 13 beforehand, for example.

The scanner unit 15 is a processing unit for reading manuscripts and creating image data. The manuscript reading operation of the scanner unit 15 is controlled by the job control unit 21. The printer unit 16 is a processing unit for providing print output based on input image data, and is controlled by the job control unit 21. The FAX transmitting and receiving unit 17 is a processing unit for transmitting and receiving FAX data via a not-shown telephone line.

The browser 22 functioning in the CPU 10 of the image processing apparatus 1 is now described. The browser 22 obtains WEB content corresponding to an initial screen from the IWS 14 in accordance with activation of the browser 22 effected in response to an activation instruction from the user, for example, and displays the obtained initial screen in the display unit 7 of the operation panel 2. The browser 22 thus constructed shares the memory 11 with the mediation control unit 20 and the job control unit 21, wherefore a limitation is set to the use capacity of the memory 11 allowed to be used by the browser 22. Accordingly, when the browser 22 is a tab-type browser, an upper limit value (maximum display number) is set to the number of tab screens (hereinafter abbreviated as “tabs”) allowed to simultaneously open within one window. The browser 22 therefore includes a screen control unit 30, a screen number managing unit 31, a state managing unit 32, a capacity managing unit 33, a screen selecting unit 34, and a script executing unit 35 to open new tabs without exceeding the determined limitation as illustrated in FIG. 2. The following description is given on the assumption that the browser 22 is a tab-type browser.

On the other hand, the memory 11 stores screen information 41 and tab management information 42 in a storage area used by the browser 22. The screen information 41 is screen information about each tab displayed in the display unit 7. Accordingly, the volume of information of the screen information 41 stored in the memory 11 increases as the number of tabs displayed in the display unit 7 by the browser 22 increases. The tab management information 42 is information for managing states of respective tabs displayed by the browser 22, for example.

The screen control unit 30 is a unit for performing integrated control over screens displayed in the display unit 7 of the operation panel 2. The screen control unit 30 displays one window in the display unit 7 in accordance with activation of the browser 22, and controls display and cancel of respective tabs while limiting the display number of the tabs displayed in the window within the maximum display number. The screen control unit 30 further executes processes for obtaining WEB content from the IWS 14 or the external server device 5, and displaying the WEB content in the respective tabs. When opening a new tab and displaying WEB content therein, the screen control unit 30 stores in the memory 11 the screen information 41 to be displayed in the new tab, and adds information about the new tab to the tab management information 42. When canceling and closing a tab already opened, the screen control unit 30 deletes information corresponding to the cancel target tab from the tab management information 42. For displaying a window in the display unit 7 by operation of the browser 22, the window may be formed in such a manner that a window frame of the window becomes invisible to the user.

The screen number managing unit 31 manages the maximum display number of tabs to be displayed within one window. The maximum display number is a value set beforehand based on the storage capacity of the memory 11, for example. The maximum display number may be changed from a factory setting value to other values by a manager of the image processing apparatus 1, for example. The screen number managing unit 31 manages the maximum display number thus determined, and notifies the screen control unit 30 about the maximum display number.

The state managing unit 32 is a processing unit which manages execution states of processes in respective tabs displayed by the screen control unit 30, and registers the execution states in the tab management information 42. Examples of the execution states of the tabs managed by the state managing unit 32 include a state of continuation of job setting operation by the user, a state of continuation of manuscript reading operation, a state of continuation of communication processing such as downloading or uploading files, and a state of continuation of print output operation, for example. Whether or not the current state corresponds to anyone of these states is determined based on information contained in particular tag information described in HTTP, for example. Accordingly, the state managing unit 32 determines the execution states of the respective tabs with reference to the tag information. When a tab displayed by the screen control unit 30 is under execution continuation of any one of the foregoing processes, the state managing unit 32 puts in the tab management information 42 that the corresponding tab is under operation.

The capacity managing unit 33 is a processing unit which manages the storage capacity of the memory 11 used by the respective tabs displayed by the screen control unit 30. More specifically, every time the screen control unit 30 opens a new tab, the capacity managing unit 33 detects the use capacity of the memory used by a screen displayed in the new tab, and puts the use capacity in the tab management information 42.

The screen selecting unit 34 is a processing unit which classifies tabs into continuous display screens of tabs for continuous display, and cancel target screens of tabs as cancel targets based on execution states of respective tabs managed by the state managing unit 32. When at least one tab is closed by the screen control unit 30, the screen selecting unit 34 determines a tab in the state of process continuation under management by the state managing unit 32 as a continuous display screen, and selects a tab not in the state of process continuation as a cancel target screen. Then, the screen control unit 30 closes and cancels the tab selected as the cancel target screen by the screen selecting unit 34, and continues the display state of the tab determined as the continuous display screen without closure.

The script executing unit 35 is a processing unit which operates when execution of a script is designated by input operation from the user to a display screen of a tab displayed in the display unit 7. The script executing unit 35 is capable of executing various types of scripts included in WEB content, and carrying out processes defined in the respective scripts.

Some scripts contained in WEB content and executed by the script executing unit 35 require the screen control unit 30 to open a new tab. More specifically, when a process for opening a new tab is defined in a script corresponding to an execution target, the script executing unit 35 issues an instruction for opening a new tab to the screen control unit 30 to allow the screen control unit 30 to start a process for opening a new tab. In this case, the screen control unit 30 determines whether or not the display number of tabs already opened is the maximum display number. When the display number of the tabs is smaller than the maximum display number, the screen control unit 30 opens a new tab. On the other hand, when the display number of the tabs is the maximum number, the screen control unit 30 closes one of the plural tabs currently opened, and opens a new tab. In this case, the screen control unit 30 is configured to open the new tab while closing the tab selected as the cancel target screen by the screen selecting unit 34 without closure of tabs in the state of process continuation under management. When plural tabs are selected as cancel target screens by the screen selecting unit 34, the screen control unit 30 closes a tab requiring a large memory use capacity under management by the capacity managing unit 33 as priority in the plural cancel target tabs so as to efficiently release the memory 11. Moreover, when the user issues an instruction for closing all the tabs and ends the browser, the screen control unit 30 similarly closes only the tabs determined as the cancel target screens by the screen selecting unit 34 and does not close the tab in the state of process continuation under management.

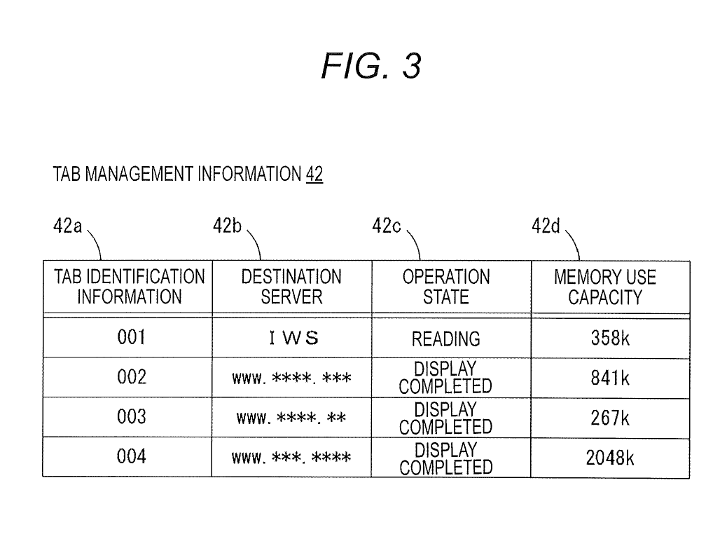

FIG. 3 is a figure illustrating an example of the tab management information 42. The tab management information 42 illustrated in FIG. 3 contains four tabs displayed by the screen control unit 30. The tab management information 42 is information in the form of a table illustrated in FIG. 3, for example, where tab identification information 42a, a destination server 42b, an operation state 42c, and a memory use capacity 42d are recorded for each of the tabs displayed by the screen control unit 30. Identification information corresponding to a new tab, and information for specifying a destination server of the new tab are recorded in an item of the tab identification information 42a and an item of the destination server 42b, respectively, every time a new tab is opened by the screen control unit 30. Moreover, execution states of respective tabs managed by the state managing unit 32 are recorded in items of the operation state 42c. The items of the operation state 42c are updated in real time when the execution states of the respective tabs are changed. The memory use capacities for respective tabs managed by the capacity managing unit 33 are recorded in items of the memory use capacity 42d. Reference to the tab management information 42 thus created allows real-time recognition of the display states of the respective tabs, for example.

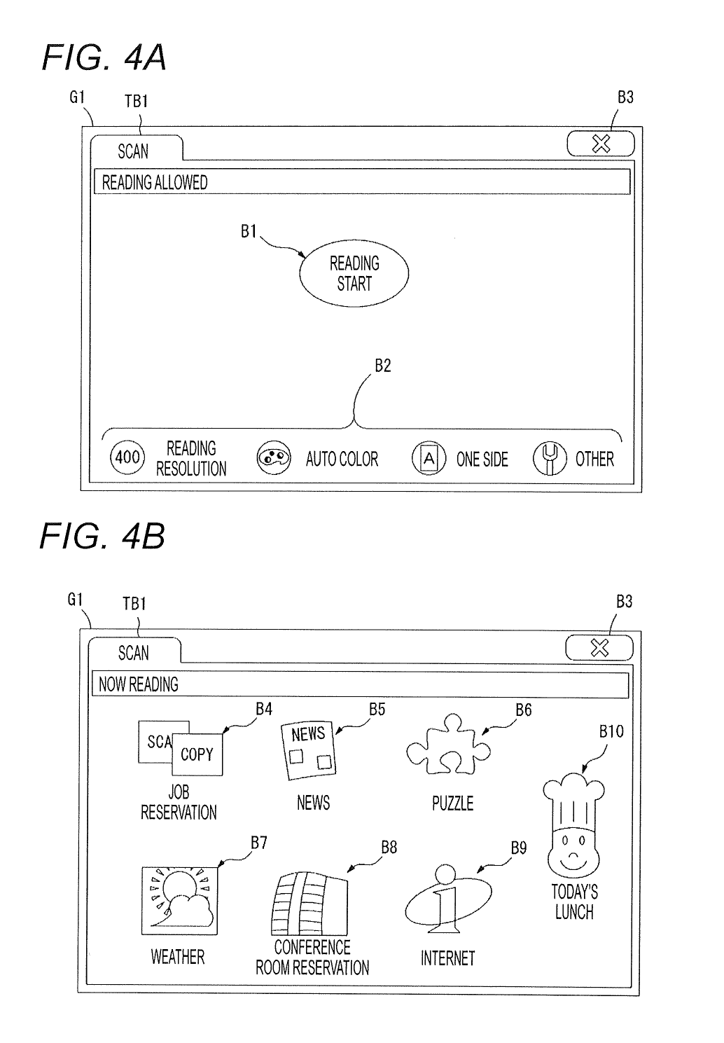

An example of a display screen G1 displayed in the display unit 7 by the browser 22 is now discussed with reference to FIGS. 4A through 6. With activation of the browser 22 in the CPU 10, the screen control unit 30 opens at least one initial tab, and obtains WEB content from the IWS 14 or the server device 5 based on an initial address set in the browser 22 beforehand to display an initial screen in the initial tab. FIG. 4A illustrates an example of the screen displayed in the initial tab. According to the example illustrated in FIG. 4A, only a tab TB1 is opened by the browser 22, displaying a screen operated when the scan function is performed. This screen is displayed based on WEB content provided by the IWS 14, for example. The WEB content of the display screen shown in the tab TB1 contains a reading start button B1 for issuing an instruction for starting manuscript reading, and a button B2 for determining various types of settings for manuscript reading, for example. An all tab cancel button B3 for closing all tabs and ends the browser 22 is provided outside the tab TB1 and at the right upper corner of the display area of the display unit 7. After setting a manuscript, the user operates the start button B1 contained in the tab TB1 in the state of display as illustrated in FIG. 4A. In response to this operation, a script associated with the reading start button B1 starts execution, issuing an instruction for manuscript reading to the job control unit 21. In response to this instruction, the scanner unit 15 starts manuscript reading operation.

Moreover, with execution of the script associated with the reading start button B1, the screen control unit 30 updates the WEB content displayed in the tab TB1, and switches the display state illustrated in FIG. 4A to a display state illustrated in FIG. 4B based on the instruction from the script executing unit 35. FIG. 4B illustrates a screen display example during manuscript reading operation by the scan function. With display of this screen, the operation state 42c of the tab management information 42 corresponding to the tab TB1 is updated to a state “reading”. According to the screen example illustrated in FIG. 4B, plural link buttons B4 through B10 are displayed in the screen so that the user can select a next job reservation, news browsing or the like. The link buttons B4 through B10 are buttons each associated with a script which opens a new tab and displays WEB content of the corresponding link. Accordingly, the screen control unit 30 opens a new tab and displays WEB content of the corresponding link every time the user operates any of the plural link buttons B4 through B10 during manuscript reading.

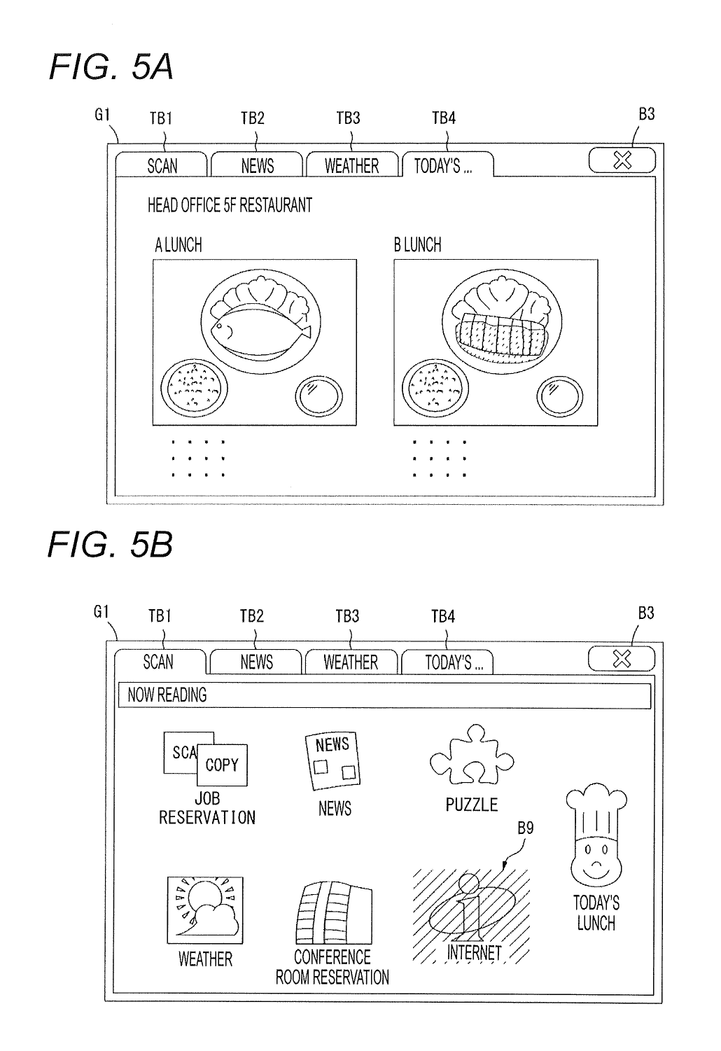

FIG. 5A illustrates a display screen example shown when the user operates the plural link buttons during manuscript reading. When the user operates the three link buttons B5, B7, and B10 in this order, for example, the browser 22 sequentially opens new tabs TB2, TB3, and TB4 every time the user operates the button to display WEB content of the corresponding links in the respective tabs TB2, TB3, and TB4. In this case, the browser 22 displays the new tab on the front side of the tab previously opened, wherefore the display screen of the previously opened tab is positioned on the rear side of the display screen of the new tab. As a result, the user does not visually recognize the display screen of the previously opened tab. However, the user may select the tab positioned on the rear side of the other tabs by touching the tab, and display the tab corresponding to the touch operation on the forefront screen.

With display of the new tab by the screen control unit 30, the capacity managing unit 33 detects and stores the memory use capacity before display of the new tab, and again detects the memory use capacity after display of the new tab. Then, the capacity managing unit 33 calculates the capacity of the memory 11 used by the new tab based on calculation of the difference between the memory use capacities before display of the new tab and after display of the new tab. The capacity managing unit 33 puts the calculated capacity in the tab management information 42 as the memory use capacity of the new tab.

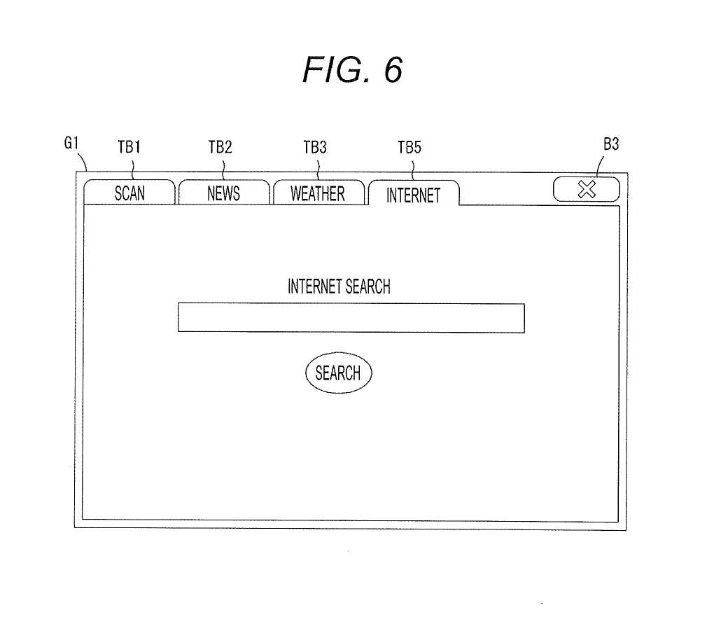

An example illustrated in FIG. 5B is a case where the user further operates a different link button B9 in the condition of display of the four tabs TB1, TB2, TB3, and TB4. In this case, the script executing unit 35 executes a script associated with the link button B9, wherefore the screen control unit 30 starts a process for opening a new tab for displaying WEB content of the link associated with the link button B9. For example, when the maximum display number of the tabs displayed by the browser 22 is “4”, the screen control unit 30 closes one of the four tabs TB1, TB2, TB3, and TB4, and then opens the new tab. When the tab management information 42 is in the condition illustrated in FIG. 3, for example, the screen selecting unit 34 checks items of the operation state 42c corresponding to the respective tabs, and then determines the tab TB1 corresponding to identification information “001” indicating “reading” as a continuous display screen, and selects the tabs TB2, TB3, and TB4 corresponding to other identification “002”, “003”, and “004” as cancel target screens. The plural cancel target screens are selected by the screen selecting unit 34, wherefore the screen control unit 30 refers to the tab management information 42, and selects one tab indicating the maximum memory use capacity from the plural cancel target screens to determine the selected tab as a tab to be canceled. According to the example illustrated in FIG. 3, the memory use capacity used by the tab TB4 corresponding to the identification information “004” indicates the maximum value, wherefore the screen control unit 30 determines the tab TB4 as one tab to be canceled. By canceling and closing the determined one tab TB4, the screen control unit 30 updates the display state to a state where the tab display number is smaller than the maximum display number, and opens the new tab under this condition to display WEB content of the link associated with the link button B9. As a result, the display state of the screen in the display unit 7 shifts to a display state illustrated in FIG. 6. Accordingly, the browser 22 closes the tab TB4 and opens the new tab TB5 without the necessity of closing the tab TB1 indicating manuscript reading by the scan function, allowing display of new WEB content in the new tab TB5 without interruption of the manuscript reading operation by the scanner unit 15 in the midst of processing. Moreover, the screen control unit 30 efficiently releases the memory 11 by closing the tab TB4 indicating the maximum memory use capacity, thereby increasing the processing efficiency in case of execution of other processing by the image processing apparatus 1.

When the all tab cancel button B3 is operated by the user in the condition of display of the plural tabs TB1, TB2, T33, and TB5 as illustrated in FIG. 6, the screen control unit 30 starts a processing for closing each of the plural tabs TB1, TB2, TB3, and TB5. In this case, the screen selecting unit 34 checks items of the operation state 42c of the tab management information 42 corresponding to the respective tabs, and classifies the tabs into continuous display screens and cancel target screens similarly to the foregoing example. Then, the screen control unit 30 continues the display state of the tabs determined by the screen selecting unit 34 as continuous display screens without closure, and closes all the tabs determined as cancel target screens. As a result, the display state of the display unit 7 shifts from the display state illustrated in FIG. 6 to the display state illustrated in FIG. 4B. In this case, the display state of the tab TB1 indicating continuation of manuscript reading continues, wherefore the activation state of the browser 22 continues. Accordingly, the browser 22 closes all of the tabs other than TB1, and does not close the tab TB1 even when the user erroneously operates the all tab cancel button B3 without noticing the state of reading continuation of the tab TB1 positioned on the rear side of the tab TB5. As a result, the user notices that the reading process is continuing in the tab TB1 which continues the display state.

Accordingly, in response to operation of the all tab cancel button B3 by the user, the browser 22 closes all tabs not in the state of process continuation. In this case, the browser 22 does not close a tab in the state of process continuation to continue the display state of the tab. This structure allows continuation of manuscript reading operation by the scanner unit 15 without interruption of the operation in the midst of processing.

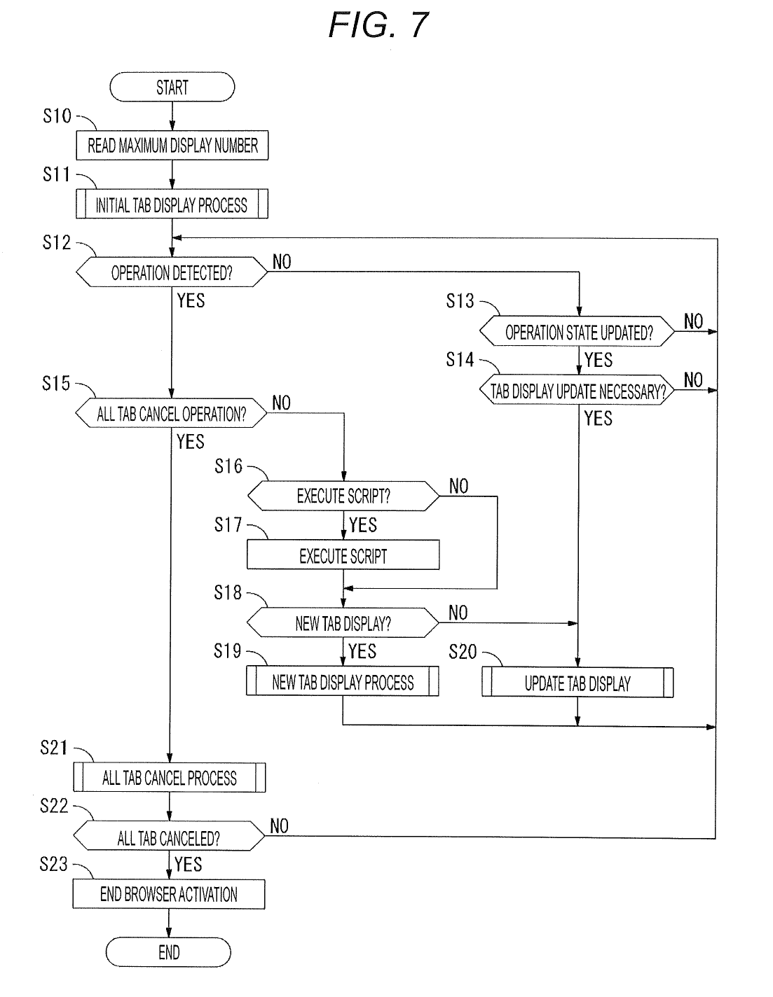

Procedures of a process executed by the browser 22 are now discussed. FIGS. 7 through 11 are flowcharts showing an example of procedures of the process executed by the browser 22. This process is started in accordance with activation of the browser 22, and executed by the foregoing screen control unit 30, screen number managing unit 31, state managing unit 32, capacity managing unit 33, screen selecting unit 34, and script executing unit 35 in cooperation with each other. With activation of the browser 22 in the CPU 10, the browser 22 initially reads the tab maximum display number (step S10). This process is a process for managing the tab maximum number and prohibiting display of tabs exceeding the maximum display number. Then, the browser 22 executes an initial tab display process (step S11). The initial tab display process is a process for displaying WEB content corresponding to an initial setting in accordance with activation of the browser 22.

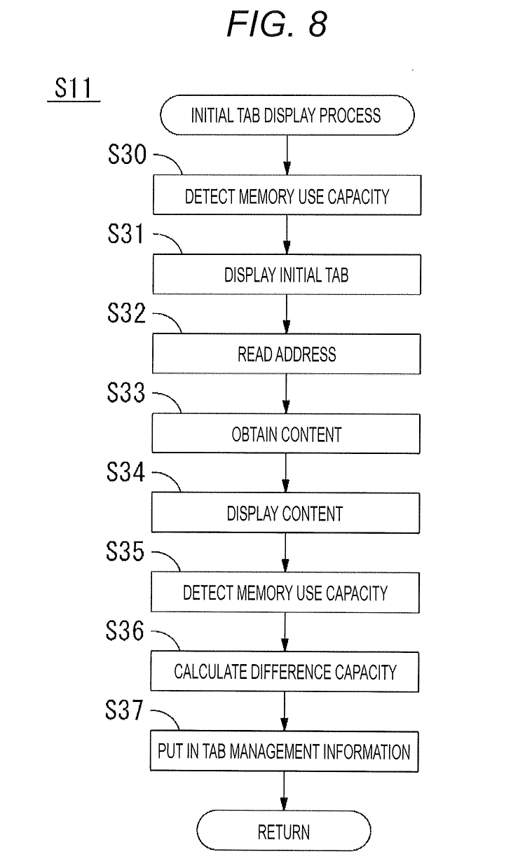

FIG. 8 is a flowchart showing an example of detailed procedures of the initial tab display process (step S11). With start of this process, the browser 22 detects the use capacity of the memory 11 before opening a new tab (step S30). Then, the browser 22 opens and displays an initial tab for displaying WEB content corresponding to the initial setting (step S31), reads an address for obtaining the WEB content (step S32), obtains the WEB content based on the address (step S33), and displays the WEB content in the initial tab (step S34). After completion of the WEB content display process, the browser 22 detects the use capacity of the memory 11 in the condition of display of the WEB content in the initial tab (step S35), and calculates the difference capacity between the use capacities detected in step S30 and in step S35 (step S36). Then, the browser 22 puts the calculated difference capacity in the tab management information 42 as the memory use capacity used by the initial tab (step S37). The initial tab display process is now completed, and the flow proceeds to step S12 in FIG. 7.

The browser 22 determines whether or not operation by the user has been detected (step S12). When it is determined that operation by the user has not been detected (NO in step S12), the browser 22 determines whether or not the operation state of the tab displayed in the display unit 7 has been updated (step S13). In this step, the browser 22 determines whether or not the execution state of the process has been changed, such as update of the tab from the state of manuscript reading to the state of completion of manuscript reading. When it is determined that the operation state of the tab has been updated (YES in step S13), the browser 22 determines whether or not the display state of the tab needs to be updated (step S14). When it is determined that update of the display state is needed, the flow proceeds to step S20. When it is determined that the operation state of the tab has not been updated (NO in step S13), or that update of the display of the tab is not needed (NO in step S14), the process executed by the browser 22 returns to step S12.

When it is determined that operation by the user has been detected (YES in step S12), the browser 22 determines whether or not the corresponding operation is all tab cancel operation using the all tab cancel button B3 (step S15). When it is determined that the operation is not the all tab cancel operation in this step (NO in step S15), the browser 22 determines whether or not a script is to be executed based on the operation by the user (step S16). When it is determined that the scrip is to be executed (YES in step S16), the browser 22 executes the script designated by the user (step S17). When it is determined that execution of the script is not needed, step S17 is skipped. Then, the browser 22 determines whether or not a new tab is to be displayed (step S18). When it is determined that a new tab is to be displayed, the browser executes a new tab display process (step S19). On the other hand, when it is determined that display of a new tab is not needed, the browser executes tab display update (step S20).

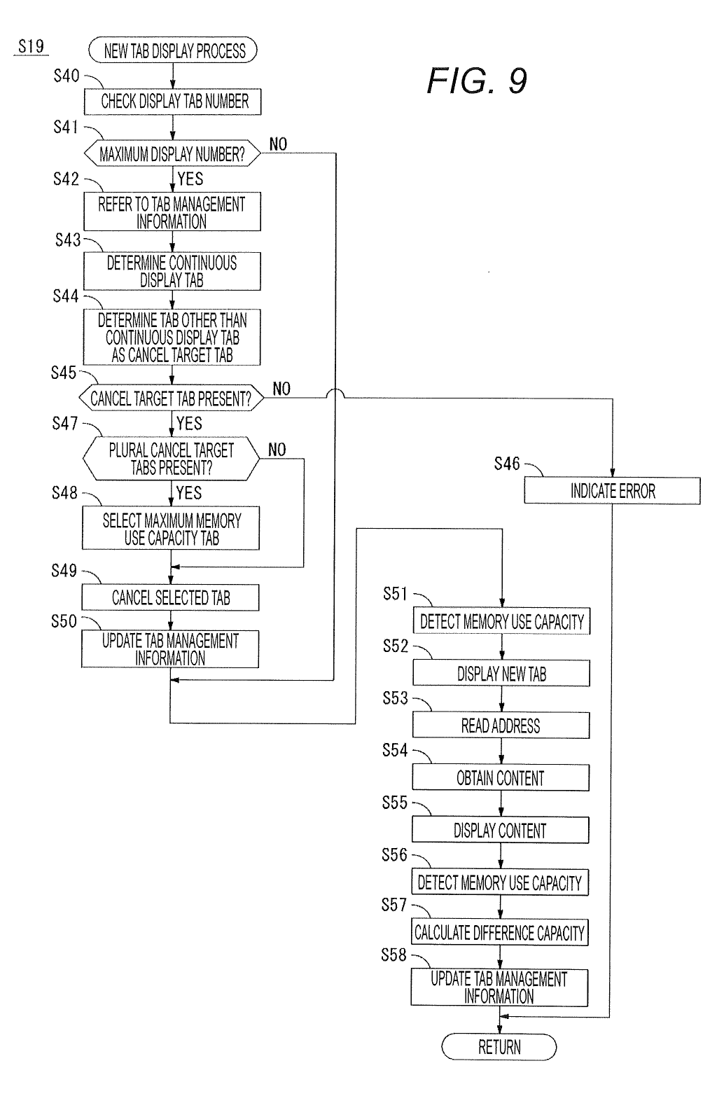

FIG. 9 is a flowchart showing an example of detailed procedures of the new tab display process (step S19). With start of this process, the browser 22 checks the current display tab number (step S40), and determines whether or not the current display tab number is the maximum display number (step S41). When it is determined that the current display tab number is the maximum display number (YES in step S41), the browser 22 refers to the tab management information 42 (step S42), and determines a tab in the state of process continuation under management in the plural tabs displayed in the display unit 7 as a continuous display tab (continuous display screen) (step S43). In addition, the browser 22 determines all the tabs not in the state of process continuation as cancel target tabs other than the continuous display tabs determined in step S43 (step S44). By the processes in steps S43 and S44, each of the plural tabs displayed in the display unit 7 is classified into a continuous display tab or a cancel target tab. There is a case, however, where all the plural tabs displayed in the display unit 7 are classified into continuous display tabs. Accordingly, the browser 22 determines whether or not a tab determined as a cancel target tab in step S44 is present (step S45). When it is determined that no cancel target tab is present (NO in step S45), a new tab is not allowed to open. Thus, the browser 22 displays error indication (step S46), and ends the new tab display process.

On the other hand, when a tab determined as a cancel target tab is present (YES in step S45), the browser 22 determines whether or not plural tabs are determined as cancel target tabs (step S47). When it is determined that plural tabs are determined as cancel target tabs (YES in step S47), the browser 22 selects a tab indicating the maximum memory use capacity from the plural tabs (step S48), and closes the selected tab to cancel the tab from the screen (step S49). Then, the browser 22 deletes information corresponding to the closed tab from the tab management information 42 in accordance with closure of the tab to update the tab management information 42 (step S50).

When it is determined that the current display tab number is not the maximum display number in step S41 (NO in step S41), closure of the displayed tabs is not needed. Accordingly, the processes in steps S42 through S50 are skipped.

Then, the browser 22 detects the use capacity of the memory 11 in the state before opening a new tab (step S51). Subsequently, the browser 22 opens and displays the new tab (step S52), reads an address of a link associated with a button or the like operated by the user (step S53), obtains WEB content based on the address (step S54), and displays the WEB content in the new tab (step S55). After completion of the display process of the WEB content in the new tab, the browser 22 detects the use capacity of the memory 11 in the state of display of the WEB content in the new tab (step S56), and calculates the difference capacity between the use capacities detected in steps S51 and S56 (step S57). Then, the browser 22 puts the difference capacity in the tab management information 42 as the memory use capacity of the new tab to update the tab management information 42 (step S58). The new tab display process is now completed, and the flow returns to step S12 in FIG. 7.

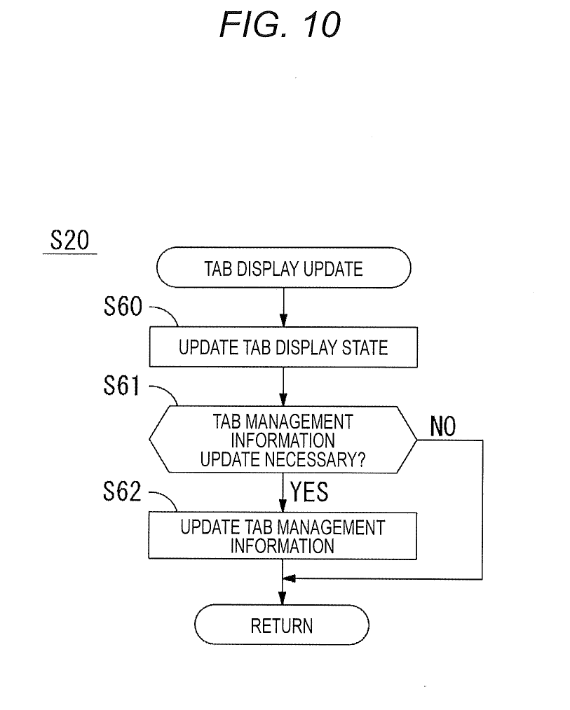

FIG. 10 is a flowchart showing an example of detailed procedures of the tab display update (step S20). With start of this process, the browser 22 updates the display state of the tabs currently displayed (step S60). Then, the browser determines whether or not update of the tab management information 42 is needed (step S61). When it is determined that update of the tab management information 42 is needed, the browser 22 updates the tab management information 42 (step S62). When it is determined that update of the tab management information 42 is not needed, step S62 is skipped. The tab display update is now completed, and the flow returns to step S12 in FIG. 7.

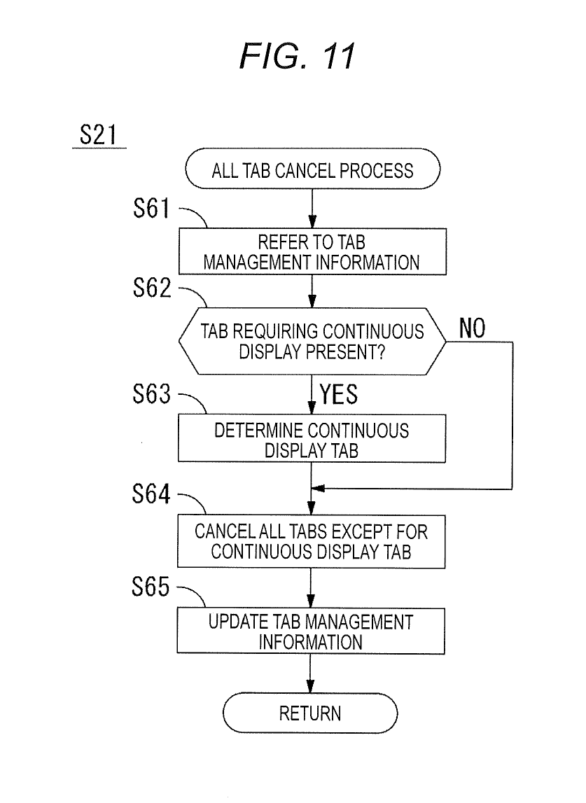

On the other hand, when it is determined that the operation by the user is the all tab cancel operation (YES in step S15), the browser 22 executes an all tab cancel process (step S21). FIG. 11 is a flowchart showing an example of detailed procedures of the all tab cancel process (step S21). With start of this process, the browser 22 refers to the tab management information 42 (step S61), and determines whether or not a tab requiring a continuous display state is present (step S62). When it is determined that a tab requiring a continuous display state is present in this step (YES in step S62), the browser 22 determines the tab as a continuous display tab (step S63). More specifically, the browser 22 refers to items of the operation state 42c of the tab management information 42, and determines a tab under execution of processing, such as manuscript reading operation, a communication process including uploading and downloading of files, print output, and setting operation by the user, as a continuous display tab. When it is determined that no tab determined as a continuous display tab is present (NO in step S62), the process in step S63 is skipped.

Then, the browser 22 closes and cancels all the tabs except for the continuous display tab (step S64), and updates the tab management information 42 (step S65). In this case, the tab management information 42 maybe deleted from the memory 11 when no continuous display tab is present. The tab display update is now completed, and the flow returns to step S12 in FIG. 7. The all cancel process is now completed, and the flow returns to step S22 in FIG. 7.

After execution of the all tab cancel process, the browser 22 determines whether or not all the tabs have been canceled (step S22). When it is determined that all the tabs have been canceled (YES in step S22), the activation state of the browser 22 is ended (step S23) to end the process. On the other hand, when a tab for continuous display remains after execution of the all tab cancel process (NO in step S22), the process executed by the browser 22 returns to step S12. Accordingly, when any of the tabs displayed in the display unit 7 is in the midst of execution of processing such as manuscript reading operation, communication processing including uploading or downloading of files, print output, and setting operation by the user, the activation state of the browser 22 does not end to continue the display state of the corresponding tab by the browser 22. Thus, interruption of processes in the state of execution continuation caused closure of by the tab is avoided. Particularly, incase of the tab-type browser, the user may erroneously execute all tab cancel operation without noticing the execution state of any process on the background proceeding in a tab disposed on the rear side of the forefront screen. Even in this case, the browser 22 continues the display state of the tab under execution of processing without closure, allowing continuous execution of the process proceeding in the tab. Accordingly, the user is not required to perform the same process again from the start, wherefore the operability and usability improve.

As described above, the display device 3 according to this embodiment includes the display unit 7 capable of displaying various types of images, and the browser 22 allowing display of each of plural display screens indicating WEB content in the display unit 7 as a tab. The browser 22 includes: the state managing unit 32 which manages an execution state of a process corresponding to each of the tabs displayed in the display unit 7; the screen selecting unit 34 which determines a tab in a state of processing continuation under management by the state managing unit 32 as a continuous display tab, and selects a tab not in the state of processing continuation as a cancel target tab in closing at least one of the plural tabs displayed in the display unit 7; and the screen control unit 30 which closes the tab selected as the cancel target tab by the screen selecting unit 34. According to this structure, the browser 22 selects and closes the tab not in the state of processing continuation, and does not close the tab in the state of processing continuation under management in closing at least one of the plural tabs displayed in the display unit 7. Accordingly, this structure avoids beforehand the problem of interruption of the processing under execution as a result of closure of the tab.

The state managing unit 32 manages a tab in the midst of uploading or downloading of files, a tab which contains a display screen receiving setting operation from the user and not yet completing setting operation by the user, a tab in the midst of manuscript reading operation, and a tab in the midst of print output, as tabs in the state of processing continuation. This structure avoids closure of these tabs by the browser 22. Accordingly, the user is not required to perform these processes again from the start, wherefore the operability and usability improve.

The browser 22 includes the screen number managing unit 31 which manages the maximum display number of the tabs allowed to be displayed in the display unit 7. The screen control unit 30 is configured to close a tab selected as a cancel target tab by the screen selecting unit 34 before display of a new tab so as to allow further display of the new tab under the condition in which the number of tabs displayed in the display unit 7 has reached the maximum display number. This structure closes the tab not in the state of processing continuation before opening the new tab. Accordingly, the new tab is allowed to open while the tab in the state of processing continuation is kept displayed within the range of limitation of the maximum display number.

The browser 22 described above includes the script executing unit 35 which executes a script designated by input operation via the operation input unit 8. In displaying a new tab based on a script executed by the script executing unit 35 under the condition in which the number of display screen displayed in the display unit 7 has reached the maximum display number, the screen control unit 30 closes a tab selected as a cancel target tab by the screen selecting unit 34 before displaying the new tab executed by the script executing unit 35. This structure allows opening of a new tab while continuing the display state of the tab under processing continuation even at the time of automatic display of the new tab based on execution of the script by the browser 22.

When the screen selecting unit 34 selects plural tabs as cancel target tabs, the screen control unit 30 selects and closes one of the tabs indicating the maximum memory use capacity in the plural tabs selected as cancel target tabs. This structure efficiently releases the storage area of the memory 11 occupied by the browser 22.

The present invention is not limited to the specific examples discussed in this embodiment presented only by way of example, but may be practiced otherwise in various manners including the following modifications.

For example, while the display device 3 is provided as the operation panel 2 of the image processing apparatus 1 in this embodiment, the display device 3 is not limited to this example. More specifically, the display device 3 according to the present invention is not limited to the operation panel 2 of the image processing apparatus 1, but may be applicable to portable display devices such as smartphones and tablet-type devices, or may be display devices incorporated in personal computers.

The example according to this embodiment is an example chiefly discussed on the assumption that the browser 22 is a tab-type browser. However, the browser 22 is not limited to this example but may be a window-type browser. More specifically, in either cases of the tab-type browser or the Window-type browser, each of plural tabs or windows corresponds to an individual display screen for displaying WEB content as a similarity of these cases. When a limitation is established for the number of the display screens to be displayed in the display unit 7, it is preferable that the processes discussed in this embodiment are applied. Accordingly, the processes described herein are applicable to the window-type browser.

According to this embodiment, it is chiefly discussed that the browser 22 displays a new tab after closing a tab not in the state of processing continuation at the time of automatic opening of the new tab by execution of a script by the browser 22. However, the browser 22 may open a new tab in response to manual operation by the user as well as in response to execution of the script. In this case, it is preferable that the browser 22 displays the new tab after closure of a tab not in the state of processing continuation when the number of the display screens has reached the maximum display number in opening the new tab in response to the manual operation by the user similarly to the above example.

According to this embodiment, the state managing unit 32 refers to analysis of information contained in particular tag information described in HTTP, for example, in determining the execution state of a process corresponding to each tab displayed in the display unit 7. However, the state managing unit 32 may determine whether or not the destination server of each tab is a server designated beforehand, for example, and regards a tab corresponding to the designated server as a tab in the state of processing continuation. When this determination method is adopted, WEB content provided by a particular cloud server designated beforehand, for example, are kept displayed as WEB content in the display state. In this case, the process for file uploading or downloading to or from the cloud server is not interrupted in the midst of processing.

According to this embodiment, the image processing apparatus 1 incorporates the IWS 14. However, the image processing apparatus 1 is not required to contain the IWS 14. For example, the external server device 5 associated with the image processing apparatus 1 may provide display screens used for the scan function of the image processing apparatus 1 as the WEB content 9.

According to an embodiment of the present invention, display of a display screen in the state of processing continuation is continued, while a display screen not in the state of processing continuation is closed when closing a display screen showing WEB content. This structure avoids beforehand automatic interruption of a process under execution as a result of closure of the display screen.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A display device comprising:
a display unit that displays various types of images; and
a browser that allows display of plural display screens showing WEB content in the display unit,
wherein the browser executes processing of
managing an execution state of a process corresponding to each of the display screens displayed in the display unit,
determining a display screen in a state of processing continuation under management as a continuous display screen, and selecting a display screen not in the state of processing continuation as a cancel target screen in closing at least one of the plural display screens displayed in the display unit, and
closing the display screen selected as the cancel target screen.

2. The display device according to claim 1, wherein the browser manages a display screen in the midst of uploading or downloading a file as a display screen in the state of processing continuation.

3. The display device according to claim 1, wherein the browser manages a display screen which receives setting operation from a user and does not yet complete setting operation by the user as a display screen in the state of processing continuation.

4. The display device according to claim 1, wherein the browser manages a display screen in the midst of manuscript reading operation as a display screen in the state of processing continuation.

5. The display device according to claim 1, wherein the browser manages a display screen in the midst of print output as a display screen in the state of processing continuation.

6. The display device according to claim 1, wherein
the browser further executes a processing of managing the maximum display number of display screens allowed to be displayed in the display unit, and
the browser displays a new display screen after closing a display screen selected as the cancel target screen in further displaying the new display screen under the condition in which the number of display screens displayed in the display unit has reached the maximum display number.

7. The display device according to claim 6, wherein
the browser further executes processes of
receiving input operation from the user via a display screen displayed in the display unit, and
executing a script designated by the input operation, and
the browser displays a new display screen after closing a display screen selected as the cancel target screen in displaying the new display screen under the condition in which the number of display screens displayed in the display unit has reached the maximum display number.

8. The display device according to claim 1, wherein the browser selects and closes one display screen indicating the maximum storage area use capacity in plural display screens selected as the cancel target screens when the plural display screens are selected as the cancel target screens.

9. The display device according to claim 8, wherein
the browser further executes a process of calculating a difference capacity between a storage area use capacity before display of the new display screen in the display unit and a storage area use capacity after display of the new display screen, and managing the difference capacity in association with the new display screen, and
the browser selects one display screen indicating the maximum storage area use capacity based on the difference capacity associated with each of the plural display screens selected as the cancel target screens.

10. The display device according to claim 1, wherein the browser displays each of the plural display screens as a tab screen switchable within one window.

11. A display control method of a browser that allows display of plural display screens showing WEB content in a predetermined display unit, the method comprising:
(a) managing an execution state of a process corresponding to each of the display screens displayed in the display unit;
(b) determining a display screen in a state of processing continuation under management in (a) as a continuous display screen, and selecting a display screen not in the state of processing continuation as a cancel target screen in closing at least one of the plural display screens displayed in the display unit; and
(c) closing the display screen selected as the cancel target screen in (b).

12. The display control method according to claim 11 further comprising:
(d) managing the maximum display number of display screens allowed to be displayed in the display unit, wherein a new display screen is displayed after closing a display screen selected as the cancel target screen in (b) in further displaying the new display screen under the condition in which the number of display screens displayed in the display unit has reached the maximum display number in (c).

13. The display control method according to claim 12 further comprising:
(e) receiving input operation from the user via a display screen displayed in the display unit, and
(f) executing a script designated by the input operation in (e),
wherein a new display screen is displayed in (f) after closing a display screen selected as the cancel target screen in (b) in displaying the new display screen under the condition in which the number of display screens displayed in the display unit has reached the maximum display number in (c).

14. The display control method according to claim 11, wherein one display screen indicating the maximum storage area use capacity in plural display screens selected as the cancel target screens is selected and closed in (c) when the plural display screens are selected as the cancel target screens in (b).

15. The display control method according to claim 14 further comprising:
(g) calculating a difference capacity between a storage area use capacity before display of the new display screen on the display unit and a storage area use capacity after display of the new display screen, and managing the difference capacity in association with the new display screen,
wherein one display screen indicating the maximum storage area use capacity is selected and closed based on the difference capacity associated with each of the plural display screens selected as the cancel target screens in (c).

16. A non-transitory recording medium storing a computer readable program executed by a computer that includes a browser capable of displaying plural display screens showing WEB content, the program allows the computer to execute the processes of:
(a) managing an execution state of a process corresponding to each of the display screens displayed by the browser;
(b) determining a display screen in a state of processing continuation under management in (a) as a continuous display screen, and selecting a display screen not in the state of processing continuation as a cancel target screen in closing at least one of the plural display screens displayed in the display unit; and
(c) closing the display screen selected as the cancel target screen in (b).

17. The non-transitory recording medium storing a computer readable program according to claim 16, wherein the program further allows the computer to execute
(d) managing the maximum display number of display screens allowed to be displayed in the display unit, wherein a new display screen is displayed after closing a display screen selected as the cancel target screen in (b) in further displaying the new display screen under the condition in which the number of display screens displayed in the display unit has reached the maximum display number in (c).

18. The non-transitory recording medium storing a computer readable program according to claim 17, wherein the program further allows the computer to execute
(e) receiving input operation from the user via a display screen displayed in the display unit, and
(f) executing a script designated by the input operation in (e),
wherein a new display screen is displayed in (f) after closing a display screen selected as the cancel target screen in (b) in displaying the new display screen under the condition in which the number of display screens displayed in the display unit has reached the maximum display number in (c).

19. The non-transitory recording medium storing a computer readable program according to claim 16, wherein one display screen indicating the maximum storage area use capacity in plural display screens selected as the cancel target screens is selected and closed in (c) when the plural display screens are selected as the cancel target screens in (b).

20. The non-transitory recording medium storing a computer readable program according to claim 19, wherein the program further allows the computer to execute
(g) calculating a difference capacity between a storage area use capacity before display of the new display screen in the display unit and a storage area use capacity after display of the new display screen, and managing the difference capacity in association with the new display screen,
wherein one display screen indicating the maximum storage area use capacity is selected and closed based on the difference capacity associated with each of the plural display screens selected as the cancel target screens in (c).
